(19) United States
(12) Patent Application Publication
(10) Pub. No.: US 2022/0388185 A1
(43) Pub. Date: Dec. 8, 2022

(54) HUNTING KNIFE AND SCALPEL WITH INTERCHANGEABLE BLADES

(71) Applicant: 3D HOLDING COMPANY, LLC, Scottsdale, AZ (US)

(72) Inventor: Calvin DUDLEY, Lynchburg, VA (US)

(21) Appl. No.: 17/775,014

(22) PCT Filed: Nov. 6, 2020
(86) PCT No.: PCT/US2020/059422

§ 371 Date: May 6, 2022

Related U.S. Application Data
(60) Provisional application No. 62/932,088, filed on Nov. 7, 2019.

(51) Int. Cl. B26B 1/04; B26B 5/00; B26B 11/00

(52) U.S. Cl. CPC B26B 1/042; B26B 5/00; B26B 11/00

(57) ABSTRACT

Knives having removable blades are described. Such a knife includes a handle; and a blade removably connected to the handle. The blade includes a blade portion and a carrier portion. The carrier portion of the blade includes a cam slot and the handle includes a cam pin which enable the blade to be removably connected to the handle.

### RELATED APPLICATION

The present application is related to, and claims priority from, U.S. Provisional Patent Application No. 62/932,088, filed Nov. 7, 2019, entitled “HUNTING KNIFE WITH INTERCHANGEABLE BLADES” to Calvin Dudley, the entire disclosure of which is incorporated here by reference.

### TECHNICAL FIELD

Embodiments described herein relate in general to knives and, more particularly, to knives which are designed to have interchangeable blades.

### BACKGROUND

Hunting knives are frequently sold as kits of various different types of knives used to clean animals in the field. Such a hunting knife kit could include, for example, a caping knife used for close, detail work, a blunt tip, serrated knife with a guthook for easily opening the animal, a deep-belly skinning knife for removing an animal's hide, a boning knife for de-boning the animal and a bone saw for cutting through an animal's bones. Those skilled in the hunting arts will appreciate that more, fewer and different knives can be included in a hunting knife kit and that the foregoing is simply an example.

Some hunting knife kits provide each of these knives with the blade integrally formed or connected to its handle. This makes these kits bulky and difficult to easily carry.

Another challenge associated with such hunting knife kits is keeping knives sharp enough to enable easy cleaning of an animal. Constantly sharpening the knife blades can become a chore.

Thus some hunting knives enable blade replacement to reduce or eliminate the need for sharpening. However many of these hunting knives suffer from either a danger that the hunter might cut him or herself while changing the blades and/or that the mechanism which enables the blade to be replaced provides a wobbly connection between the blade and the handle of the knife.

Accordingly, it would be desirable to provide knives which address these and other problems.

### SUMMARY

According to embodiments, knives having replaceable/interchangeable blades which are safe and easy to use are described.

According to an embodiment, a knife includes a handle and a blade removably connected to the handle. The blade includes a blade portion and a carrier portion. The carrier portion of the blade includes a cam slot and the handle includes a cam pin which enable the blade to be removably connected to the handle.

According to another embodiment, a knife kit includes a single handle and a plurality of different blades removably connectable to the single handle. Each of the plurality of different blades includes a blade portion and a carrier portion. The carrier portion of each of the plurality of blades includes a cam slot and the single handle includes a cam pin which enable each of the plurality of blades to be removably connected to the single handle.

According to yet another embodiment, includes a handle; and a blade removably connected to the handle. The blade includes a slot having at least two different widths and the handle includes a retention bar configured be fit into the slot in the blade. The retention bar is configured to be inserted into the slot at a portion thereof having a first width. The retention bar includes around its circumference a groove which is configured to mate with the edges of the slot.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1A depicts a side view of a knife according to an embodiment with the side plate and handle removed;

FIG. 1B shows a side plate for the knife of FIG. 1A;

FIG. 1C shows a handle piece for the knife of FIG. 1A;

FIGS. 2A-2C show how an end portion of a carrier portion of the knife of FIG. 1A can be slid onto a cam pin and locked onto the handle of the knife;

FIG. 3A illustrates the knife of FIG.1A with the side plate and handle piece attached thereto;

FIG. 3B illustrates the knife of FIG.1A with the side plate and handle piece attached thereto and with the blade partially folded toward the handle;

FIGS. 4A-4B depict other blades which can be interchanged with the main blade shown in FIG. 1A;

FIGS. 5A-5B show a scalpel blade which is removably connected to a carrier portion according to an embodiment;

FIGS. 6A-6B show a scalpel blade which is removably connected to a carrier portion according to an embodiment; and

FIG. 7 illustrates an end of a knife handle having a sharpener and a lanyard hole according to an embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

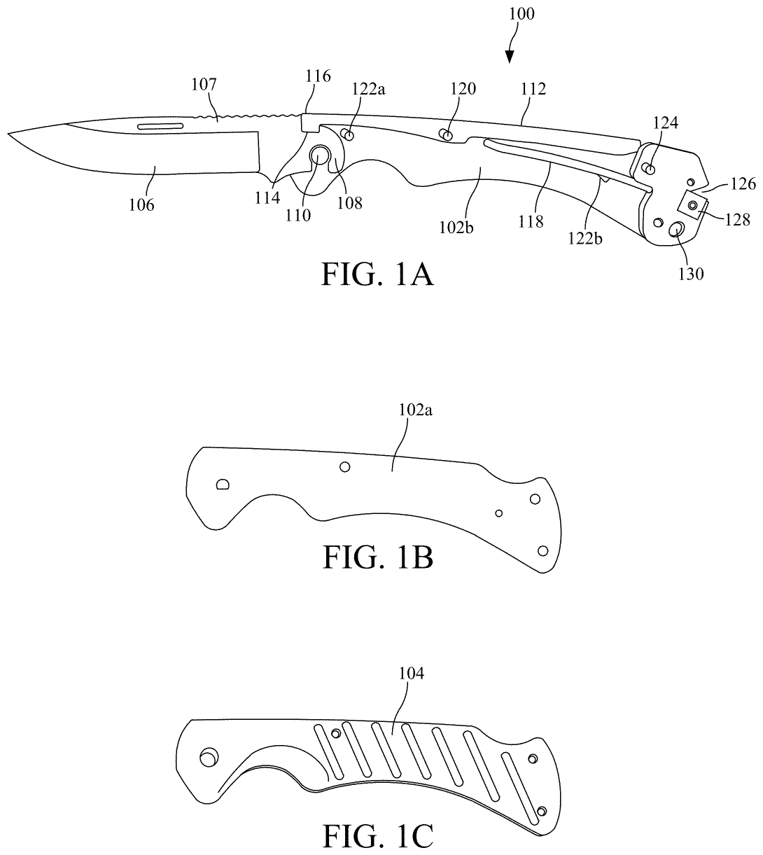

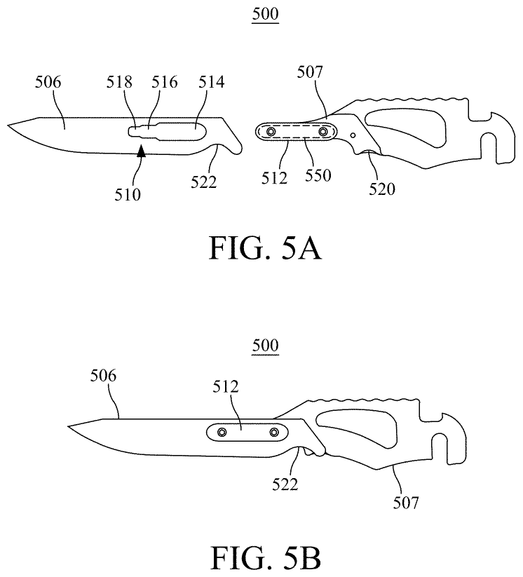

According to various embodiments described herein, knives are presented with a number of convenient features including, for example, easy and safe mechanisms for replacing knife blades, easy and safe sharpening of knife blades and many other features. Referring first to the embodiment of FIGS. 1A-1C, an embodiment of a knife 100 which is designed to accept various different blades is illustrated in a partially disassembled, exploded view. In FIG. 1A, the knife 100 is shown with one of the side plates 102a (which is shown in FIG. 1 B) and one of the exterior grip handle pieces 104 (which is shown in FIG. 1C) removed to expose the inner workings of the knife mechanisms. Starting from left to right in FIG. 1A, the blade 106 and its carrier portion 107 (which may be formed integrally with the blade 106, as shown in this embodiment, or which may be formed as a separate element as described below with respect to the embodiment of FIGS. 5A and 5B) is shown attached to the other side plate 102b behind the blade portion via a hooking element 108 which is looped over a cam pin 110 and also via a front portion 116 of a lock bar 112 which is inserted into a detent 114 formed above and beside the hooking element 108, thereby creating a sort of ratchet and pawl type of connection between the hooking element 108 and the lock bar 112. The lock bar 112 is spring loaded so that, in its normal state, the front portion 116 of the lock bar 112 is forced into the detent 114 to aid in retention of the blade 106 and carrier portion 107 in the knife 100. A lock bar spring 118 is provided toward the rear of the knife 100 to perform this biasing of the lock bar 112 in the blade retention mode by providing a force to the rear of the lock bar 112 which pivots the front portion 116 of the lock bar 112 into the detent 114 around the illustrated hinge pin 120 when the knife 100 is in the locked position.

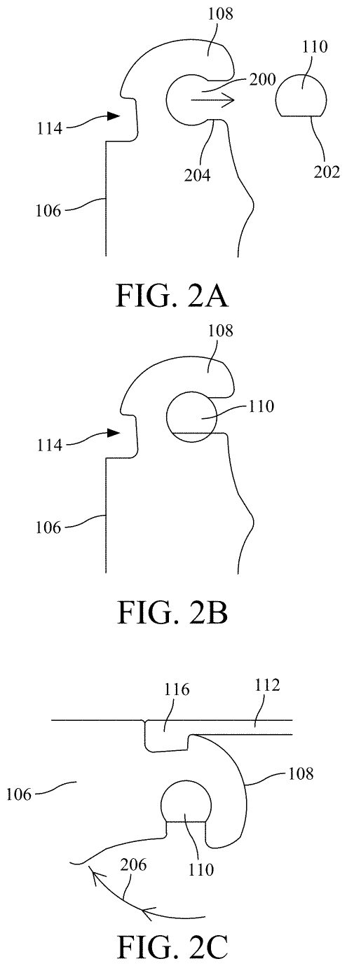

The manner in which the blade 106 can be rotated onto the cam pin 110 to lock the blade 106 onto the rest of the knife 100 will now be described in more detail with respect to FIGS. 2A-2C. Holding the blade 106 at approximately a 90 degree angle relative to the side plate 102b, and referring to FIG. 2A, the cam slot formed in the hooking element 108 can be slid over the cam pin 110 aided by the flat edge 202 of the cam pin 110 interacting with the flat edge 204 of the cam slot 200. This results in the blade 106 and the side plate 102b being mechanically engaged as shown in FIG. 2B. Then by rotating the blade portion 106 clockwise by about 90 degrees (as shown by arrow 206 in FIG. 2C) such that it is substantially in line with the handle 104, the front portion 116 of the lock bar 112 will follow the curved outer surface of the hooking element 108 until it snaps into the detent 114 under the force of the lock bar spring 118.

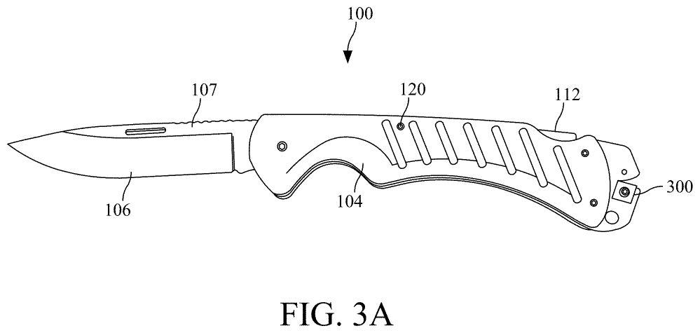

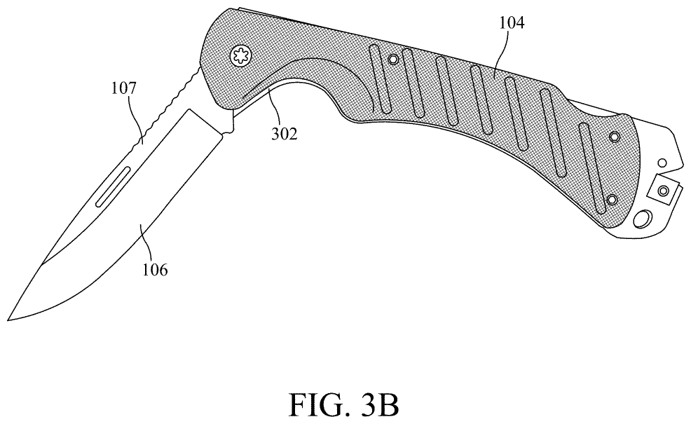

FIG. 3A illustrates a knife 100 which has its side plate 102a and handle 104 attached. To remove a blade from the knife 100, the exposed portion of the lock bar 112 is depressed at the top of the handle 104 which pivots the lock bar front portion 116 around the hinge pin 120 and out of the detent 114 in the carrier portion 107, thereby releasing the blade 106 and carrier portion 107 from its locked position. The blade 106 and carrier portion 107 is then rotated by approximately 90 degrees counterclockwise, e.g., such that the tip of the blade 106 is pointing down if the knife 100 is being held horizontally. This enables the user to slide the blade (blade portion 106 and carrier portion 107) to the left, i.e., the reverse the arrow shown in FIG. 2A, such that the cam pin 110 exits the cam slot 200 in the hooking element 108 while at the same time the front portion 116 of the lock bar 112, which was previously locking the knife 100 into the handle 104 via the detent 114, now rides the curved surface of the hooking element 108 beside the detent 114 as the blade 106, 107 slides out of the handle 104. The cam pin 110 around which the hooking element 108 is looped when in the locked position can have a horizontal flat side 202 which, as mentioned previously, enables the blade 106, 107 to more easily slide on and off of the knife when the lock bar 112 is depressed in the rear to pivot the front portion 116 of the lock bar 112 away from the detent 114 formed in the carrier portion above and beside the hooking element 108 and the blade 106 has been rotated by about 90 degrees and is being slid off.

An indexable knife sharpening element 300 is shown at the end of the handle 104 along with a corresponding opening through which a knife blade 106 can be slid against the element 300 to sharpen the blade 106. Knife sharpeners according to various embodiments are described in more detail below. An embodiment of the knife 100 of FIGS. 1A and 3A can be seen in FIG. 3B with the main blade 106, 107 attached and partially folded. A slot 302 can be formed in the bottom of the knife 100 which enables the blade 106, 107 to be fully folded into the handle.

Returning to FIGS. 1A-1C to complete the description thereof, also shown in FIG. 1A are spacer/retainer pins 122a, 124 disposed in each side plate 102a and 102b to create space between the two side plates when the knife 100 is assembled (pin 122a also servers to support the locking bar 112, as well as four holes in the side plates 102a, 102b and exterior grip handles 104 (seen in FIGS. 1B and 1C) to accommodate the cam pin 110, hinge pin 120 and two rear inside threaded pins (not shown) which can be used to hold the handles 104 in place. Pin 122b serves to keep tension on spring 118. According to another embodiment, described below, the inside fastener pins can also be used to hold a sharpener 126 in place against the handle of the knife 100.

At the rearmost portion of the knife 100 illustrated in FIG. 1A, one or more indexing tungsten carbide bits 128 can be provided to enable resharpening of the removable blades, as well as a lanyard hole 130, both of which are optional elements to the knife 100 of FIG. 1A. Moreover, the side plates 102a, 102b and exterior grip handles 104 can also include an oblong forefinger relieve slot and a thumb indentation slot as illustrated. According to other embodiments, one or both of these slots can be omitted.

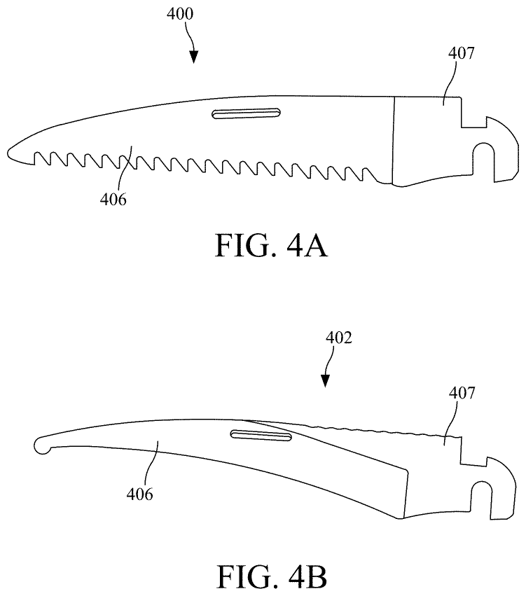

Turning now to FIGS. 4A and 4B, since the knife 100 is designed to easily and safely change blades, a variety of other types of blades can be provided as part of a knife kit which other blades can be interchanged with the main blade 106, 107. Specifically, shown in FIGS. 4A and 4B are a saw blade 400 and a bull nose skinning blade 402, respectively. Note that both of the saw blade 400 and bull nose skinning blade 402 include a blade portion 406 a carrier portion 407. The carrier portion 407 is designed similarly to the carrier portion 107 of the main blade 106 shown in FIG. 1A and described above in that they include both a hooking element and a detent above the hooking element to engage with the cam pin and locking bar in the same way that the main blade does in FIG. 1A. These carrier portions 407 can be formed integrally with the blade portion 406 or can be removably attached to the blade portion.

An example of a knife embodiment wherein the carrier portion is removably attached to the blade portion (and also removably attached to the handle) will now be described with respect to FIGS. 5A-5B. This embodiment is referred to herein as scalpel blade/razor blade attachment 500. In this embodiment the carrier portion 507 of the blade 500 is removably attachable to the blade portion 506 of the scalpel blade 500. In FIG. 5A, the scalpel blade 500 is shown with the blade portion 506 and the carrier portion 507 disconnected from one another. The blade portion 506 of the scalpel blade 500 includes a slot or opening 510 therethrough which enables the blade portion 506 to be slidably affixed to the carrier portion 507 of the scalpel blade 507 when the slot 510 is placed over the retention bar 512 and then slid onto the retention bar 512. The retention bar 512 includes a groove 550, e.g., a V-shaped groove, cut into the circumference of the retention bar 512 and into which the edges of the slot 510 are inserted when the slot 510 of the blade portion 506 of the scalpel blade 500 is slid over the retention bar 512 of the carrier portion 507 to connect the two elements.

It can be seen in FIG. 5A, that the slot 510 formed in the blade portion 506 has three different widths, a first width 514 toward the rear of the slot 510, a second width 516 in the middle of the slot 510 and a third width 518 at the front of the slot 510 (i.e., the portion of the slot 510 closest to the tip of the blade portion 506). The first width 514 is larger than the second width 516 and the second width 516 is larger than the third width 518, i.e., the slot 510 of the blade portion 506 tapers. This tapering of the slot 510 enables the top and bottom edges of the slot 510 to initially easily slide into the V-groove in the retention bar 512 of the carrier portion 507 due to the wider first width 514 of the slot. As the slot width narrows, and as the blade portion 506 is being slid onto the retention bar 512 of the carrier portion 507, the continued narrowing width of the slot 510 along with the depth of the V-groove 550 has the effect of making the connection between the carrier portion 507 and the blade portion 506 tighter and tighter until, when the blade portion 506 is fully slid onto the carrier 507, the connection between the blade portion 506 and the carrier portion 507 is wiggle free.

Those skilled in the art will appreciate that although the embodiment shown in FIG. 5A has a slot 510 with three different widths to provide a gradual tightening of the blade portion 506 onto the carrier portion 507 that other slot profiles could be used in the alternative. For example, slot 510 could have two different widths or four different widths. Alternatively, the width of the slot 510 could gradually and continuously taper from a larger width which is wide enough to accept the width of the retention bar 512 to a narrower width which suffices to provide a tight, wiggle free connection.

Also visible on the carrier portion 507 of the scalpel blade 500 is a ball detent (unnumbered) which holds the end of the blade portion 506 slightly up away from the carrier portion 507 which, in conjunction with a finger slot 520, 522, enables the user to lift the end of the blade portion 506 up during removal of the blade portion. By making the blade portion 506 removable from the carrier 507, the blade portion 506 can be disposable and the carrier portion 507 can be reused with other blade portions 506. In FIG. 5B, the scalpel blade 500 is shown with the blade portion 506 and carrier portion 507 connected together. In this view it can be seen that when connected, a portion of the blade 506 overhangs the carrier 507 at the finger slot 522 to enable a user to easily push the blade 506 away from the carrier prior to sliding the blade back off of the carrier. While the scalpel blade illustrated in FIG. 5B is configured to be connected to the handle 104, just like the other blades described herein using the illustrated hooking element and detent, it is also configured to be usable independently of the handle 104, i.e., as a knife unto itself. Thus the carrier portion is configured as illustrated in FIGS. 5A and 5B to be easily gripped by a hand and also can operate as a handle if desired.

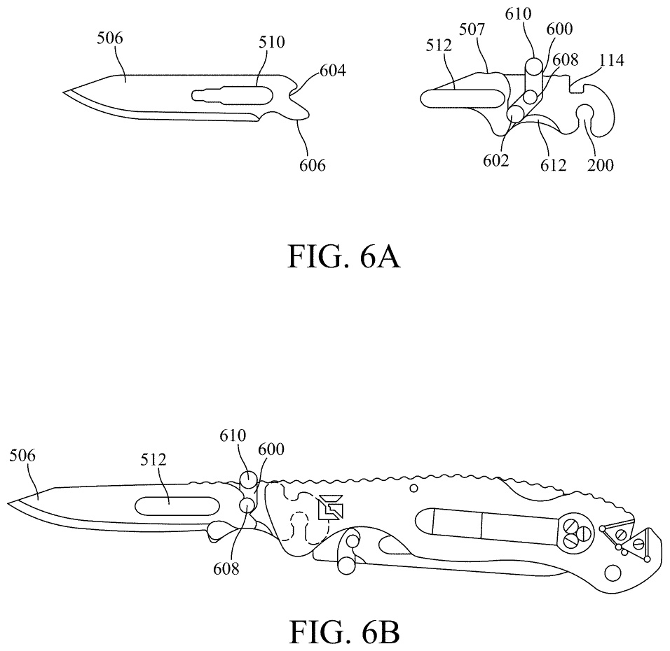

In the embodiment of FIGS. 5A-5B, the scalpel blade 506 is manually slid onto and off of the carrier portion 507. FIG. 6A shows another embodiment of the scalpel blade wherein the blade portion 506 is pushed off of the carrier portion using a mechanical lever 600 connected to the carrier portion 507 via a hinge point 602. It will be seen that the rearmost surface of the blade portion 506 is shaped differently in the embodiment of FIG. 6A relative to the embodiment of FIG. 5A. Specifically, in FIG. 5A the rearmost surface of the blade portion 506 is straight, whereas in the embodiment of FIG. 6A, the rearmost surface of the blade portion 506 includes an indentation 604 and a lift tab 606. When the blade portion 506 is slid all the way onto the retention bar 512, a stud 608 disposed on the lever 600 will fit into the indentation 604. In this way, when the knife user wants to remove the blade portion 506, she or he can move the lever 600 forward by pressing the thumb stud 610 toward the blade portion 506. This has the effect of also moving the stud 608 which is disposed on the lever 600 toward the blade portion 506 as the lever 600 pivots around hinge point 602. Since the stud 608 is in physical contact with the indentation 604 of the blade portion 506, this has the effect of pushing the blade portion forward so that the retention bar 512 moves backward in the slot 510 until it reaches the widest part 514 of the slot 510 and can then be removed manually using the tab 606 which is operable via finger slot 612.

FIG. 6B shows another embodiment of the scalpel knife with the mechanical lever 600, stud 608 and thumb stud 610 with the scalpel blade 506 connected to the carrier portion 507 such that the thumb stud is inserted into indentation 604 and is in contact with the blade portion 506.

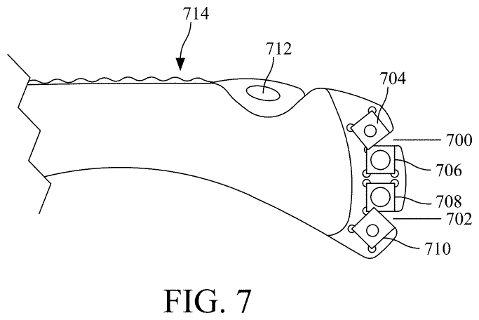

As mentioned above, according to some embodiments, it may be desirable to include one or more knife sharpeners in the knife itself. According to some embodiments, the end of the knife handle 104 can include either (or both) of a ceramic knife sharpener 700 or a (micro-grain) tungsten carbide knife sharpener 702 as seen in FIG. 7. The sharpener(s) 700, 702 can (e.g., on one side of the knife) be formed using one or more indexable sharpening elements. In the embodiment of FIG. 7 each of the sharpeners 700 and 702 has two indexable sharpening elements 704, 706 and 708, 710, respectively, disposed next to two grooves, also indicated by reference numbers 700 and 702, respectively. In operation, a knife user can remove the blade(s) as described above, hold the handle 104 in one hand, the blade in the other hand, and slide the blade through the groove to sharpen the blade against the edges of the sharpening elements 704, 706 or 708, 710 which face the respective groove 700 or 702. Although optional, according to an embodiment it may be useful to provide both the ceramic sharpener 700 and the tungsten sharpener 702 as the tungsten sharpener 702 provides a good introductory sharp edge to a blade, whereas the ceramic sharpener 700 provides a keen finishing edge to the blade. According to one embodiment, this can be accomplished by creating a dual ceramic/tungsten sharpening element by epoxy gluing a ceramic sharpening element to a tungsten sharpening element.

Moreover, the elements 704, 706 and 708, 710 can be made to be rotatably attached to the sharpener so that the edges of the sharpening element which face the grooves 700 and 702 can be changed by rotating (indexing) the elements when needed. In this way, the sharpeners 700, 702 can last, e.g., four times longer, than a fixed single edge sharpener. Although the embodiment of FIG. 7 shows square sharpening elements 704, 706, 708, 710, those skilled in the art will appreciate that the sharpening elements can take other shapes, e.g., triangular. Further, in order to make the sharpener(s) usable in either the right-hand or left-hand, the sharpening elements should sit flush with the housing of the sharpener so that a blade can be sharpened from either side of the handle without touching the handle itself as shown in FIG. 7. The knife handle shown in FIG. 7 also includes a lanyard opening 712 and a smooth ridged surface 714 for ease of gripping the knife.

It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A knife comprising:
a handle; and
a blade removably connected to the handle;
wherein the blade includes a blade portion and a carrier portion;
wherein the carrier portion of the blade includes a cam slot and the handle includes a cam pin which enable the blade to be removably connected to the handle.

2. The knife of claim 1, wherein an end of the carrier portion has a curved outer surface next to the cam slot and a detent formed next to the curved outer surface.

3. The knife of claim 2, wherein the handle includes a lock bar and further wherein the cam slot is fitted over the cam pin and the lock bar engages with the detent of the carrier portion when the blade is connected to the handle.

4. The knife of claim 3, wherein the lock bar is spring biased to engage with the detent when the blade portion and the carrier portion are in a locked position.

5. The knife of claim 4, further comprising a lock bar release which, when actuated, lifts the lock bar out of engagement with the detent.

6. The knife of claim 5, wherein the carrier portion is configured to be rotatable around the cam pin when the lock bar release is actuated.

7. The knife of claim 6, wherein when the blade portion has been rotated to approximately a 90 degree angle relative to the handle, the blade including the blade portion and the carrier portion is slidably removable from the cam pin.

8. The knife of claim 1, wherein the blade portion and carrier portion are integrally joined together.

9. The knife of claim 1, wherein the blade portion and the carrier portion are removably joined together.

10. The knife of claim 9, wherein the blade portion includes a slot having at least two different widths and wherein the carrier portion includes a retention bar configured be fit into the slot in the blade portion.

11. The knife of claim 10, wherein the retention bar is configured to be inserted into the slot at a portion thereof having a first width, wherein the retention bar includes around its circumference which is configured to mate with the edges of the slot.

12. The knife of claim 11, wherein the carrier portion and the retention bar are further configured to slide along the edges of the slot into another portion thereof having a second width which is smaller than the first width to engage the carrier portion with the blade portion.

13. The knife of claim 9, further comprising a pivotable lever disposed on the carrier portion configured to push blade portion away from the carrier portion.

14. The knife of claim 1, further comprising:
a sharpener disposed at a rear end of the handle, the sharpener having one or more indexable sharpening elements.

15. The knife of claim 14, wherein the one or more indexable sharpening elements include at least one tungsten carbide sharpening element and at least one ceramic sharpening element.

16. The knife of claim 15, wherein the tungsten carbide sharpening element and the ceramic sharpening element are glued together.

17. A knife kit comprising:
a single handle; and
a plurality of different blades removably connectable to the single handle;
wherein each of the plurality of different blades includes a blade portion and a carrier portion;
wherein the carrier portion of each of the plurality of blades includes a cam slot and the single handle includes a cam pin which enable each of the plurality of blades to be removably connected to the single handle.

18. The knife kit of claim 17, wherein an end of the carrier portion has a curved outer surface next to the cam slot and a detent formed next to the curved outer surface.

19. The knife kit of claim 18, wherein the single handle includes a lock bar and further wherein the cam slot is fitted over the cam pin and the lock bar engages with the detent of the carrier portion when one of the plurality of different blades is connected to the single handle.

20. A knife comprising:
a handle; and
a blade removably connected to the handle;
wherein the blade includes a slot having at least two different widths and wherein the handle includes a retention bar configured be fit into the slot in the blade;
wherein the retention bar is configured to be inserted into the slot at a portion thereof having a first width, wherein the retention bar includes around its circumference a groove which is configured to mate with the edges of the slot.
